(19) United States
(12) Patent Application Publication
(10) Pub. No.: US 2005/0030659 A1
(43) Pub. Date: Feb. 10, 2005

(54) Color wheel, manufacturing method of same, and color wheel assembly and image display apparatus incorporating same

(75) Inventor: Toshiaki Asakawa, Iwata-gun (JP)

Correspondence Address: OLIFF & BERRIDGE, PLC, P.O. BOX 19928, ALEXANDRIA, VA, 22320, US

(73) Assignee: MINEBEA CO., LTD., Kitasaku-gun (JP)

(21) Appl. No.: 10/909,426

(22) Filed: Aug. 3, 2004

(30) Foreign Application Priority Data
Aug. 8, 2003 (JP) 2003-289944

(51) Int. Cl. G02B 5/22; G02B 7/00

(52) U.S. Cl. 359/892; 359/889

(57) ABSTRACT

There is provided a method for manufacturing a color wheel which is structured such that plural kinds of filters functioning either to selectively transmit or to selectively reflect lights having respective different wavelength bands are formed on a disk-like substrate made of a light-transmittable material. The method comprises the steps of: forming a substrate assembly composed of the substrate and a rotary shaft disposed perpendicularly at the substrate; setting on the substrate assembly a masking jig provided with at least one opening to demarcate respective filters of the plural kinds, wherein the masking jig is positioned with reference to the rotary shaft; and forming the respective filters at the substrate assembly with the masking jig set on.

### BACKGROUND OF THE INVENTION

1. Field of the Invention

The present invention relates to a manufacturing method of a color wheel suitable for use as a filter element of a time-share light dispersing device, and to a color wheel fabricated by the manufacturing method and incorporated in a color wheel assembly making up a projection-type image display apparatus.

2. Description of the Related Art

Color composition in a projection-type image display apparatus has conventionally been accomplished commonly by a method, such as: a single-panel method, in which one light valve element adapted to control light amount per pixel thereby creating an image is used to disperse each pixel into R (red), G (green), and B (blue) lights; and a three-panel method, in which three light valve elements dedicated to R, G and B lights, respectively, are used to produce R, G and B images in parallel, and then the three images thus produced are composed. Recently, as a light valve element capable of fast switching, such as a ferroelectric liquid crystal display element or a digital micro-mirror device, is increasingly coming into practical use, a time-sharing single-panel method is widely used. In the time-sharing single-panel method, R, G and B lights are caused to sequentially impinge on one light valve element, the light valve element is driven in synchronization with switching-over of the R, G and B lights thereby producing R, G and B images in a time-series manner, and the images thus produced are projected onto a screen, or the like. Here, color composition of the images is accomplished by a viewer due to an afterimage effect occurring at a sense of vision. In the time-sharing single-panel method, reduction in both dimension and weight of the apparatus, which is a feature of a single-panel method, can be achieved by employing a relatively simple optical system, and therefore the time-sharing single-panel method is favorable for realizing inexpensive fabrication of a projection-type image display apparatus. In such an image display apparatus, a color wheel is preferably used as a filter element of a time-share light dispersing device to sequentially disperse light emitted from a white light source into R, G and B lights having respective wavelength bands in a time-sharing manner.

FIGS. 9A and 9B are respectively front and side views of a typical color wheel assembly 200 provided with such a color wheel. Referring to FIG. 9B, the color wheel assembly 200 comprises a color wheel 150, a hub 105, and a motor 106. The color wheel 100 is a tricolor color wheel composed of a disk-like substrate 101 which is made of a light-transmitting material, for example, optical glass, and three pie-shaped (sectorial) filters 102, 103 and 104 which are formed on a surface of the substrate 101, and which transmit exclusively, for example, R, G and B lights, respectively. The color wheel 150 thus structured is fixedly attached to the motor 106 via the hub 105 coaxially therewith. The color wheel assembly 200 operates such that the color wheel 150 is rotated by the motor 106 so that the filters (R, G and B) 102, 103 and 104 sequentially have white light S falling incident thereon whereby the white light S is sequentially dispersed into R, G and B lights.

The filters 102, 103 and 104 are usually constituted by optical interference filters of a dielectric multi-layer film structured such that a dielectric thin film formed of a material having a high refractive index (e.g., Ta₂O₅, Nb₂O₅, TiO₂, ZrO₂, and ZnS), and a dielectric thin film formed of a material having a low refractive index (e.g., SiO₂, and MgF₂) are alternately laminated. The optical interference filter is superior in durability (heat resistance, light stability, and chemical resistance) to a color filter formed by a staining method, a pigment dispersion method, or the like, has a high transmittance, and easily achieves a sharp spectroscopic characteristic, and therefore endures exposure to intensive light flux and produces a display image of a high visual quality. Conventionally, a filter constituted by the above-described dielectric multi-layer film is often formed such that a masking jig which is made of, for example, a thin metal plate (hereinafter referred to as “metal mask”), and which has an opening to demarcate the filter is set on a substrate, the metal mask and the substrate are held inside a film forming apparatus by an appropriate fixing jig, and that the aforementioned dielectric multi-layer film is formed on the substrate by an evaporation method, a sputtering method, or the like. This is favorable in terms of production cost and environmental burden compared to, for example, a photolithographic method.

Especially when a pattern formed by filters is arranged in a rotation-symmetric manner about a given axis (usually defined by a geometric center point of the substrate), the filters can be formed by the aforementioned evaporation or sputtering method one after another by means of one and the same metal mask rotated by a predetermined angle after one filter is formed, whereby all the filters can be formed by only one metal mask rather than preparing a plurality of metal masks for respective filters (refer to, for example, Japanese Patent Application Laid-Open No. 2003-57424). In the case of the color wheel 150 shown in FIG. 9A, the filters 102, 103 and 104 are arranged to be 120 degrees rotation-symmetric about the geometric center point of the disk-like substrate 101.

Since a color wheel fulfills its function by rotating as described above, a pattern formed by filters defines a point which a rotary shaft of a motor is designed to go through (hereinafter the point is referred to as “center point”). For example, in the case of the aforementioned pattern formed to be rotation-symmetric, its center point is usually designed to coincide with the symmetry center. In this case, when the filters are formed out of alignment to one another, a definite center point of the pattern cannot be allocated, and even when the filters are formed in alignment to one another so as to enable allocation of a definite center point of the pattern, if the center point is not coincident with an actual rotation axis of the color wheel, then the filters are not aligned to one another in view of arrangement designed. If this is the case, the switching of the filters and the operation of a light valve element are brought out of synchronization in controlling an image display apparatus, and an image formed may come out with color drift. This is crucial especially in a so-called sequential color recapture (SCR) system color wheel (refer to, for example, U.S. Patent Application Laid-Open No. 2002/0005914). In such a color wheel, a pattern of filters is formed such that spiral-shaped color filters are densely arranged so that a spot of light emitted from a white light source impinges on a plurality of different filters all the time. Consequently, light filtered by the color wheel is dispersed into colors corresponding to respective colors of the filters, and a light valve element is compartmented so that compartmented sections receive respective colored lights dispersed and produce respective color images. The dispersion of light into colored lights and the compartmenting of the light valve element change with the rotation of the color wheel. In order to produce the color images without color drift in this type color wheel, the boundaries between adjacent filters must be exactly formed and located as designed, and also the center point of the pattern formed by the filters must accurately coincide with the rotation axis of the color wheel.

In a conventional method of fabricating a color wheel, however, due to error margins involved in fabricating a substrate, a masking jig, and a fixing jig for holding together the substrate and the masking jig inside a film forming apparatus, there is normally an accumulated error measuring as much as 150 μm in centricity of the center point of the pattern and in concentricity of the center point with the rotation axis of the color wheel. The accumulated error may be possibly reduced by enhancing processing accuracy at each fabricating process, but the best minimum is about 50 μm. In an image display apparatus, the error either causes images to be formed with color drift, or causes increased amount of light to be wasted for controlled prevention of the color drift thus failing to contribute to production of images, consequently lowering the usability of light. Especially in the aforementioned SCR system color wheel, the filters cannot be accurately formed and demarcated unless they are formed by a high-cost method, such as a photolithographic method.

### SUMMARY OF THE INVENTION

The present invention has been made in light of the above circumstance, and it is an object of the present invention to provide a manufacturing method of a color wheel, by which the filters are demarcated by means of a masking jig, such as a metal mask, such that the rotation axis of the color wheel is made accurately coincident with the center point of the pattern formed by the filters, and to provide a color wheel which is fabricated by the manufacturing method, and which is incorporated in a time-shared color wheel assembly and an image display apparatus.

In order to achieve above object, according to a first aspect of the present invention, there is provided a method for manufacturing a color wheel which is structured such that plural kinds of filters functioning either to selectively transmit or to selectively reflect lights having respective different wavelength bands are formed on a disk-like substrate made of a light-transmittable material. The method comprises the steps of:

forming a substrate assembly composed of the substrate and a center shaft disposed perpendicularly at the substrate;

setting on the substrate assembly a masking jig provided with at least one opening to demarcate respective filters of the plural kinds, wherein the masking jig is positioned with reference to the center shaft; and

forming the respective filters at the substrate assembly with the masking jig set on.

Since the filters are demarcated by the masking jig which is positioned with reference to the center shaft of the substrate assembly, the filters which form a pattern having its center point at a point corresponding to the center shaft can be easily formed with a demarcation of a high accuracy irrespective of error margins involved in processing the substrate and in processing a fixing jig to hold together the substrate and the masking jig inside a film forming apparatus. Also, since the center shaft constitutes a rotation axis of the color wheel, the eccentricity of the center point of the pattern with respect to the rotation axis of the color wheel is minimized.

In the first aspect of the present invention, the step of forming the respective filters may include a process of rotating at least one of the masking jig and the substrate assembly relative to each other about the center shaft of the substrate assembly to thereby shift the at least one opening. Consequently, if at least two filters are congruent with one another and are arranged rotation-symmetric about the center point, then the congruent filters can be formed by means of one and the same masking jig in a series of processing. This contributes to further minimizing the eccentricity of the center point of the pattern with respect to the rotation axis of the color wheel.

In the first aspect of the present invention, the step of forming the substrate assembly may include a process of molding the substrate and the center shaft into an integral structure. Consequently, the substrate assembly can be formed with a high accuracy.

In the first aspect of the present invention, the center shaft may be made of either a metal material or a ceramic material. The center shaft made of such a material is rigid and therefore can suitably serve as a rotary shaft of the motor to rotate the color wheel. The center shaft, when made of a ceramic material which is small in specific gravity and thermal expansion coefficient, is light in weight thereby reducing power consumption, and undergoes reduced expansion of its diameter caused by heat generated when the motor rotates at a high speed.

In the first aspect of the present invention, the at least one opening may be spiral-shaped. Consequently, an SCR system color wheel can be fabricated without using a costly photolithographic method.

According to a second aspect of the present invention, there is provided a color wheel which comprises:

a disk-like substrate made of a light-transmittable material;

a center shaft disposed perpendicularly at the substrate; and

plural kinds of filters formed on the substrate and functioning either to selectively transmit or to selectively reflect lights having respective different wavelength bands, the plural kinds of filters being formed such that a center point of a pattern formed by the filters coincides with the center shaft.

Consequently, the eccentricity of the center point of the pattern formed by the filters from the rotation axis of the color wheel is minimized, and therefore resultant shift of the pattern is also minimized.

According to a third aspect of the present invention, there is provided a color wheel assembly which comprises:

a color wheel including
a disk-like substrate made of a light-transmittable material,
a center shaft disposed perpendicularly at the substrate, and
plural kinds of filters formed on the substrate and functioning either to selectively transmit or to selectively reflect lights having respective different wavelength bands, the plural kinds of filters being formed such that a center point of a pattern formed by the filters coincides with the center shaft; and

a motor to rotate the color wheel, the motor being coupled to the color wheel such that the center shaft also serves as a rotary shaft of the motor.

Since the eccentricity of the center point of the pattern formed by the filters with respect to the rotary shaft of the motor to rotate the color wheel is minimized, the color wheel assembly can be structured with the filters undergoing a minimum positional shift from the design.

According to a fourth aspect of the present invention, there is provided an image display apparatus which comprises

a color wheel assembly comprising:
a color wheel including;
   a disk-like substrate made of a light-transmittable material,
   a center shaft disposed perpendicularly at the substrate, and
   a plural kinds of filters formed on the substrate and functioning either to selectively transmit or to selectively reflect lights having respective different wavelength bands, the plural kinds of filters being formed such that a center point of a pattern formed by the filters coincides with the center shaft; and

a motor to rotate the color wheel, the motor being coupled to the color wheel such that the center shaft also serves as a rotary shaft of the motor.

Since the switching of the filters by the rotation of the color wheel can be synchronized highly accurately with the operation of a light valve element, images produced come out with reduced color shift, and at the same time a margin in controlling operation in order to prevent color shift can be diminished, whereby a white light incident on the color wheel can be utilized with a high efficiency thus enabling an image display with a high quality.

### BRIEF DESCRIPTION OF THE DRAWINGS

FIG. 1A is a front view of one type color wheel fabricated by a first manufacturing method according to the present invention, and FIG. 1B is a side view thereof;

FIG. 2A is a front view of a masking jig used in the first manufacturing method according to the present invention, and FIG. 2B is a cross-sectional view thereof taken along a line A-A′;

FIG. 3A is a front view of a substrate assembly fabricated by the first manufacturing method according to the present invention, and FIG. 3B is a side view thereof;

FIGS. 4A to 4C show processes of forming filters in the first manufacturing method according to the present invention;

FIG. 5A is a front view of another type color wheel fabricated by a second manufacturing method according to the present invention, and FIG. 5B is a side view thereof;

FIG. 6A is a front view of a masking jig used in the second manufacturing method according to the present invention, and FIG. 6B is a cross-sectional view thereof taken along a line A-A′;

FIG. 7A is a front view of a color wheel assembly using a color wheel according to the present invention, and FIG. 7B is a side view thereof;

FIG. 8A is a construction view of an image display apparatus including a color wheel fabricated by the first manufacturing method according to the present invention, and FIG. 8B is a construction view of an image display apparatus including a color wheel fabricated by the second manufacturing method according to the present invention; and

FIG. 9A is a front view of a conventional typical color wheel assembly, and FIG. 9B is a side view thereof.

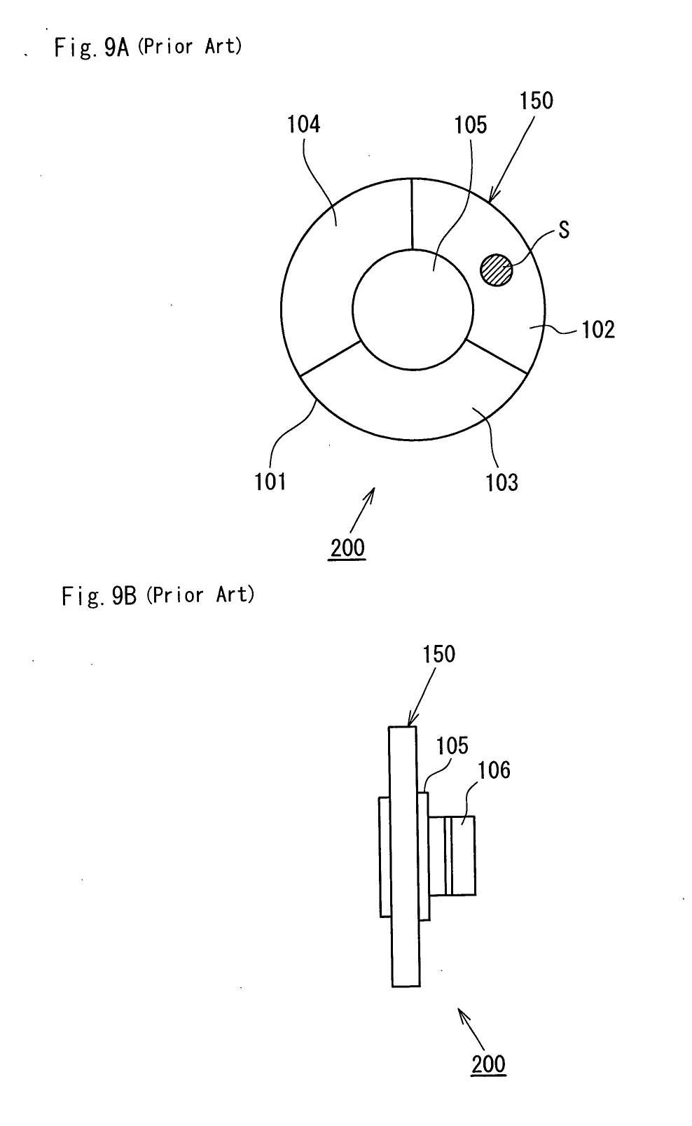

### DETAILED DESCRIPTION OF THE PREFERRED EMBODIMENTS

Preferred embodiments of the present invention will hereinafter be described with reference to the accompanying drawings. In the discussion of color wheels to follow below, each filter is adapted to transmit light with a given wavelength band only thereby performing its filter function, but the present invention is not limited thereto and includes a color wheel in which each filter performs its filter function by reflecting light with a given wavelength band only.

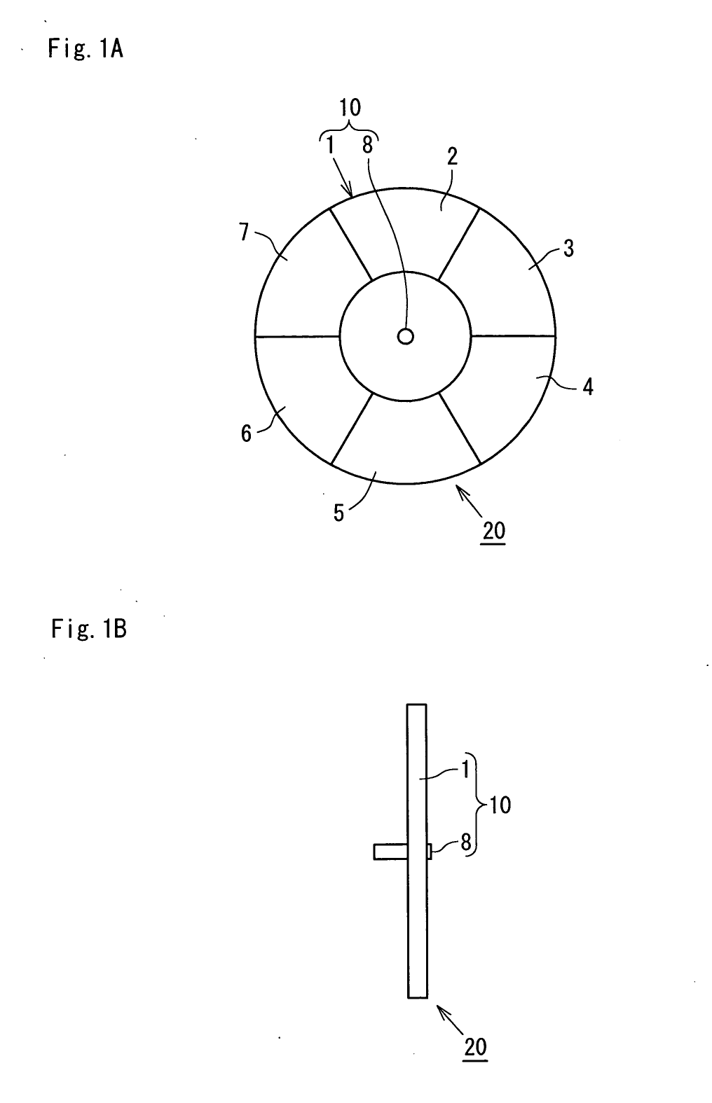

Referring to FIGS. 1A and 1B, a color wheel 20 is composed of a substrate assembly 10 which comprises a disk-like substrate 1, and a center shaft 8 perpendicularly attached to the substrate 1. The substrate 1 is formed of a light-transmittable material such as borosilicic acid glass, and has filters 2 to 7 formed on a surface thereof. The center shaft 8 is of a cylindrical metal member such as stainless steel, and is preferably set at the geometric center of the disk-like substrate 1. The filters 2 to 7 are optical interference filters of a dielectric multi-layer film formed by an evaporation method, a sputtering method, or the like, pie-shaped (sectorial), and arranged such that, for example, the filters 2 and 5 oppose directly each other and constitute R transmitting filters to transmit R light only, the filters 3 and 6 oppose directly each other and constitute G transmitting filters to transmit G light only, and the filters 4 and 7 oppose directly each other and constitute B transmitting filters to transmit B light only. The center point of the pattern formed by the filters 2 to 7 (the center point is defined as a point through which the rotation axis of the color wheel 20 is to pass) is designed to coincide with the geometric center point of a circle formed by the pie-shaped filters 2 to 7, which are formed by a method to be described later so that the center point of the pattern coincides with the center shaft 8. The filters 2 to 7 are congruent with one another and arranged to be 60 degrees rotation-symmetric about the center point of the pattern.

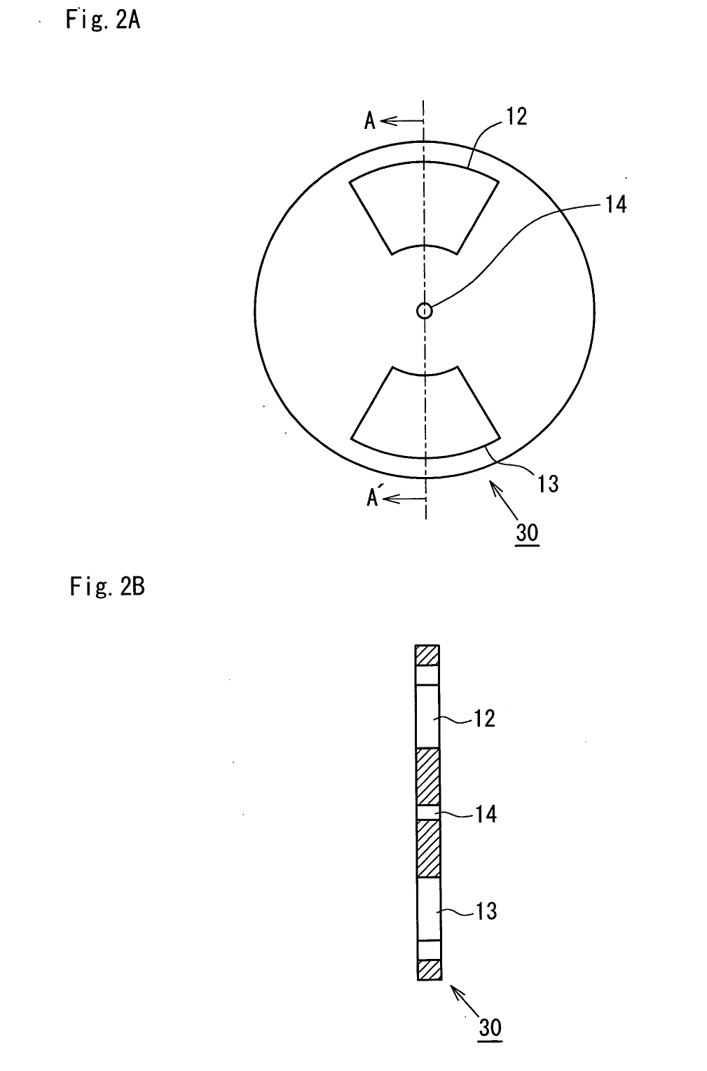

A first manufacturing method of a color wheel will be described. The color wheel 20 shown in FIG. 1 is referred to as an example in explaining the first manufacturing method. FIGS. 2A and 2B show a masking jig which is used to demarcate filters in a process of forming filters to be described later. The masking jig is shaped like a disk, formed of a thin metal sheet processed by an electroforming method, an etching method, a laser machining method, or the like, and is referred to as a metal mask 30 in the description to follow below. Referring to FIGS. 2A and 2B, the metal mask 30 has two sectorial openings 12 and 13 congruent with each other, and an insertion hole 14. The openings 12 and 13 are for demarcating filters of one color in the color wheel 20. The insertion hole 14 has a bore diameter slightly lager than the diameter of the center shaft 8 of the color wheel 20 and is usually formed by one of the above-described methods enabling an accuracy of about 10 μm. The openings 12 and 13, and the insertion hole 14 are arranged such that the center of the insertion hole 14 agrees with the center point of the pattern formed by the filters 2 to 7 demarcated by means of the openings 12 and 13, and that the openings 12 and 13 are 180 degrees rotation-symmetric about the center point.

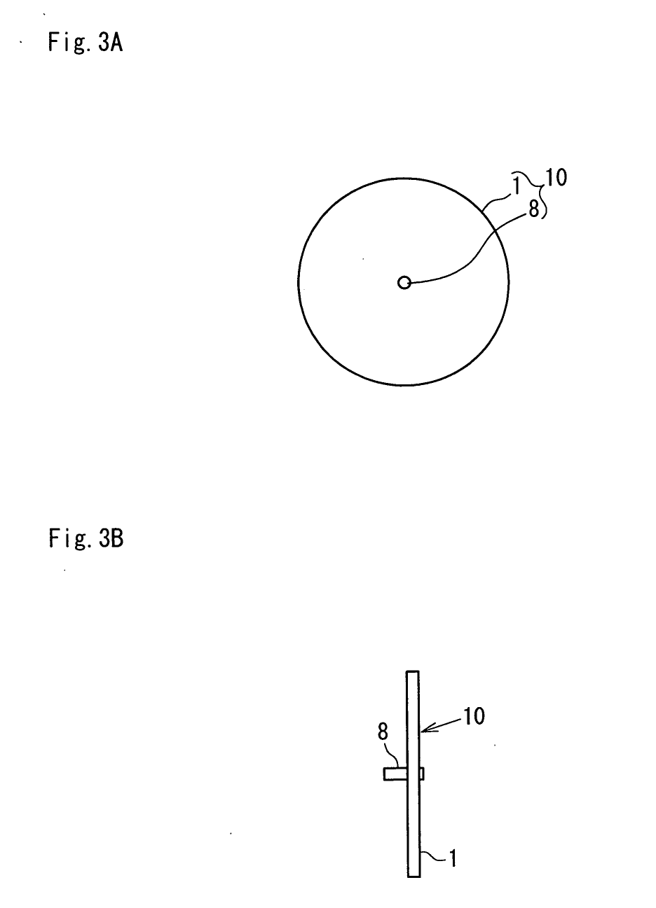

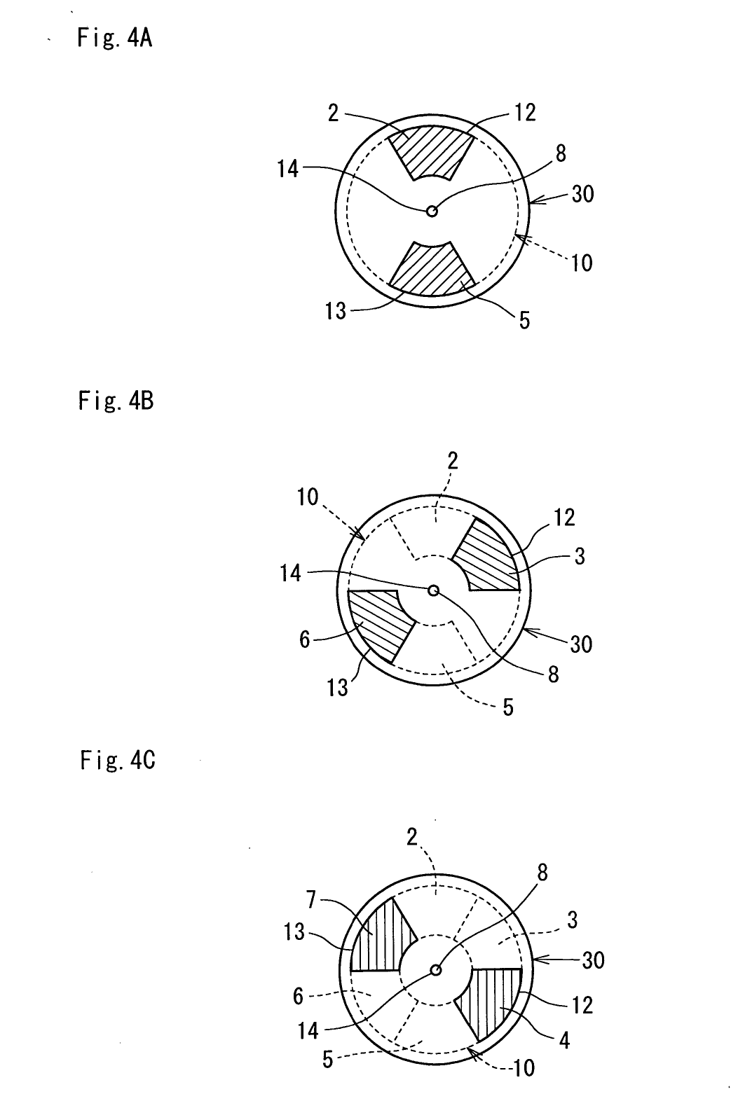

Processes in the first manufacturing method will be discussed with reference to FIGS. 3A and 3B, and 4A to 4C. In the embodiment, the substrate assembly 10 is formed in an integral structure by, for example, a press molding method, specifically such that glass blocks as a substrate material are put in a molding die in which a center shaft member is placed at a predetermined position, then are press-molded at a temperature as high as a glass softening point, and cooled down. The substrate assembly 10 formed thus is shown in FIGS. 3A and 3B. The center shaft 8 is preferably positioned at the geometric center of the disk-like substrate 1, but the eccentricity at this portion does not impact the operation and advantageous effect of the present invention as described later.

Then, the aforementioned metal mask 30 is put on the substrate assembly 10 such that the center shaft 8 of the substrate assembly 10 detachably and movably fits into the insertion hole 14 of the metal mask 30 thereby duly positioning the metal mask 30. The substrate assembly 10 and the metal mask 30 are tightly held together by a fixing jig (not shown) at their outer peripheral portions and fixedly set inside a well-known film forming apparatus (not shown) via the fixing jig, and the R transmitting filters 2 and 5 of a dielectric multi-layer film are formed (refer to FIG. 4A). Then, the fixing jig is undone, and the metal mask 30 is rotated clockwise by an angle of 60 degrees with respect to the substrate assembly 10. The substrate assembly 10 and the metal mask 30 are held together by the fixing jig gain and fixedly set inside the film forming apparatus, and the G transmitting filters 3 and 6 are formed (refer to FIG. 4B). And, the metal mask 30 is further rotated clockwise by an angle of 60 degrees with respect to the substrate assembly 10 for forming the B transmitting filters 4 and 7 (refer to FIG. 4C). The metal mask 30 is taken off, and the color wheel 20 shown in FIGS. 1A and 1B is completed.

In the color wheel 20 fabricated by the first manufacturing method according to the present invention, the center point of the pattern formed by the filters 2 to 7 is coincident with the center shaft 8 which corresponds to the insertion hole 14 of the metal mask 30. Here, the centricity of the center point of the pattern (the accuracy of the center point focusing on one point), and the concentricity thereof with the center shaft 8 are determined only by the accuracy in processing the metal mask 30, not depending, in principle, on other factors such as error margins in fabricating the substrate 1, the substrate assembly 10, and the fixing jig for holding together the substrate assembly 10 and the metal mask 30 inside the film forming apparatus.

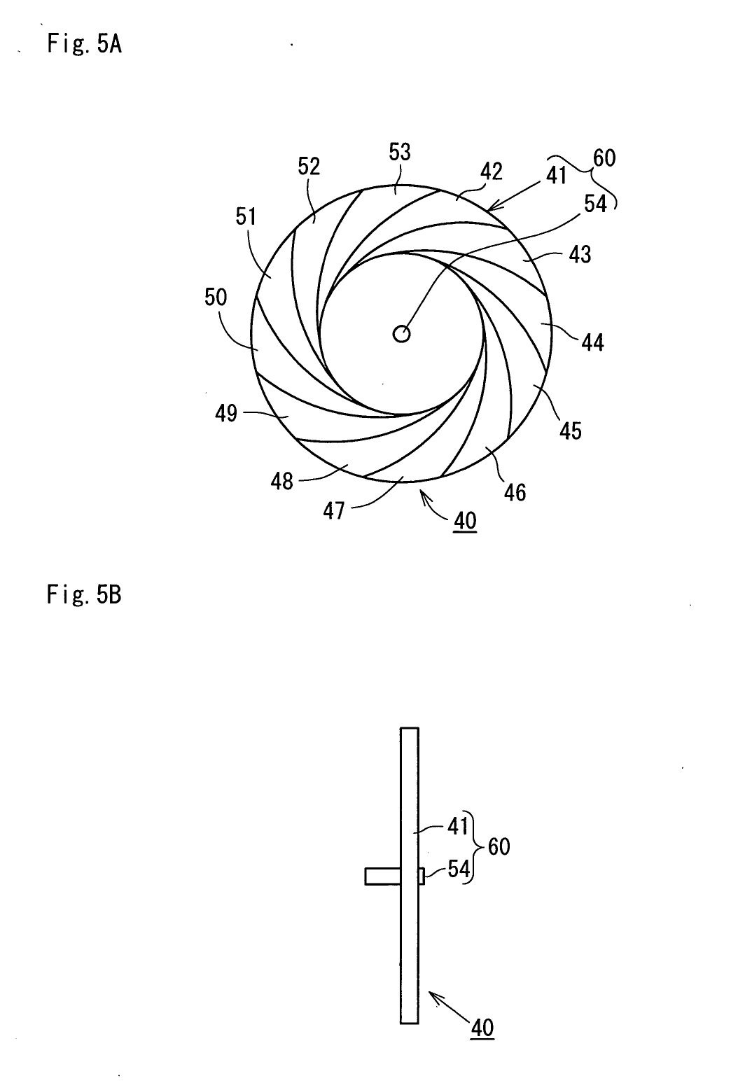

A second manufacturing method according to the present invention, which is for a color wheel provided with spiral-shaped filters, will hereinafter be discussed. A color wheel 40 shown in FIGS. 5A and 5B is composed of a substrate assembly 60 which comprises a disk-like substrate 41, and a center shaft 54 attached perpendicularly to the substrate 41. The substrate 41 is formed of a light-transmittable material such as borosilicic acid glass, and has spiral-shaped filters 42 to 53 formed on a surface thereof. The center shaft 54 is of a cylindrical metal member such as stainless steel, and is preferably set at the geometric center of the substrate 41. The filters 42 to 53 are optical interference filters of a dielectric multi-layer film formed by an evaporation method, a sputtering method, or the like, and are arranged such that, for example, the filters 42, 45, 48 and 51 constitute R transmitting filters to transmit R light only, the filters 43, 46, 49 and 52 constitute G transmitting filters to transmit G light only, and the filters 44, 47, 50 and 53 constitute B transmitting filters to transmit B light only. The center point of the pattern formed by the filters 42 to 53 (the center point is defined as a point through which the rotation axis of the color wheel 40 is to pass) is designed to coincide with the geometric center point of a circle formed by the filters 42 to 53, which are formed as described later such that the center point of the pattern coincides with the center shaft 54. The filters 42 to 53 are congruent with one another and arranged to be 30 degrees rotation-symmetric about the center point of the pattern. The color wheel 40 is preferably used as a so-called SCR system color wheel.

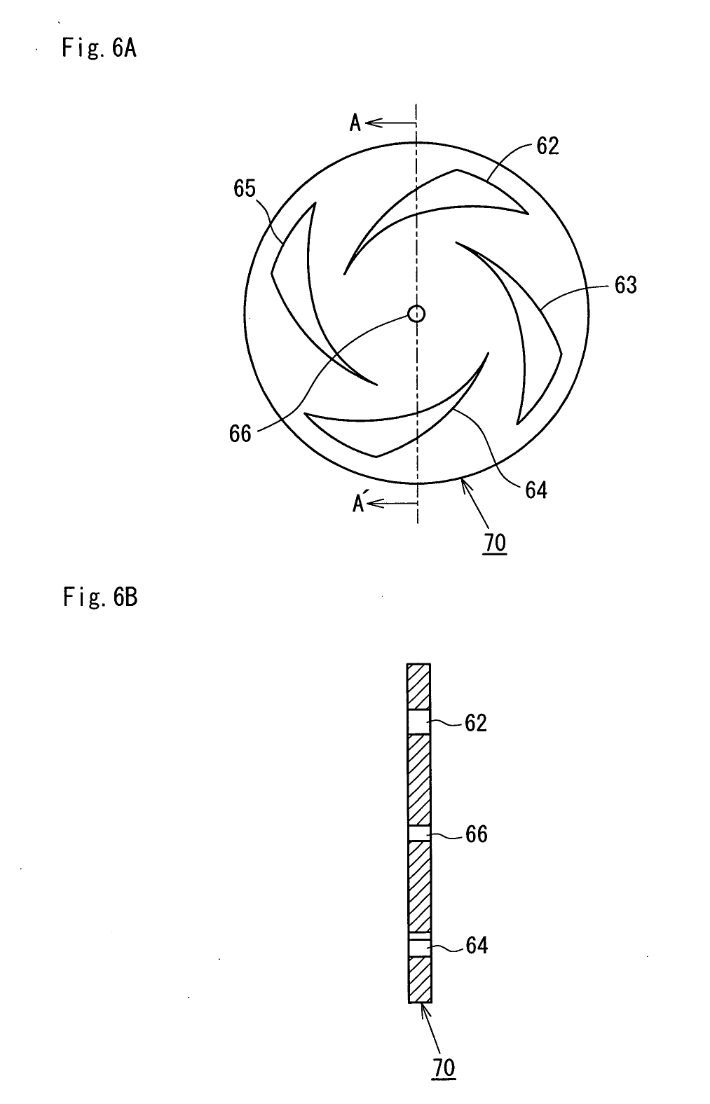

The second manufacturing method of the aforementioned color wheel 40 having spiral-shaped filters will be described. FIGS. 6A and 6B show a masking jig which is used to demarcate filters in a process of forming filters to be described later. The masking jig is shaped like a disk, formed of a thin metal sheet processed by an electroforming method, an etching method, a laser machining method, or the like, and is referred to as a metal mask 70 in the description to follow below. Referring to FIGS. 6A and 6B, the metal mask 70 has four spiral-shaped openings 62 to 65 congruent with one another, and an insertion hole 66. The openings 62 to 65 are for demarcating filters of one color in the color wheel 40. The insertion hole 66 has a bore diameter slightly lager than the diameter of the center shaft 54 of the color wheel 40 and is usually formed by one of the above-described methods enabling an accuracy of about 10 μm. The openings 62 to 65, and the insertion hole 66 are arranged such that the insertion hole 66 agrees with a center point of the pattern formed by the filters 42 to 53 demarcated by the openings 62 to 65, and that the openings 62 to 65 are 90 degrees rotation-symmetric about the center point.

The substrate assembly 60, and the filters 42 to 53 can be formed in the same way as the substrate assembly 10 and the filters 2 to 7 as described above except that the metal mask 70 is rotated by an angle of 30 degrees with respect to the substrate assembly 60.

The substrate 1/41 may alternatively be formed of an optical plastic material, such as polymethyl methacrylate, polycarbonate, polycycloolefin, and the like, and the substrate assembly 10/60 may be formed in an integral structure by a usual insert-molding with a center shaft member as an insert member placed in a molding die. The center shaft member material is not limited to the aforementioned stainless steel but may be a ceramic material having an adequate rigidity, such as alumina ceramic. The substrate assembly 10/60 in the embodiments is integrally composed of the substrate 1/41 and the center shaft 8/54, but may alternatively be structured such that the substrate 1/41 is fabricated without the center shaft 8/54 but with a hole, and the center shaft 8/54 separately prepared is fixed in the hole by press-fitting or adhesive.

In the embodiments described above, filters are congruent with one another, and a pattern formed by the filters is rotation-symmetric about its center point, but the present invention is not limited thereto but may be such that filters are not congruent with one another, and a pattern formed by the filters is not rotation-symmetric, especially such that only some of the filters are congruent or even none of the filters are congruent, in which case plural kinds of masking jigs prepared corresponding to the configurations and arrangements of the filters are applied in turn so as to form respective filters. The number of the filters is not limited to six or twelve as described in the above embodiments, and also the configuration of the liters is not limited to sector or spiral.

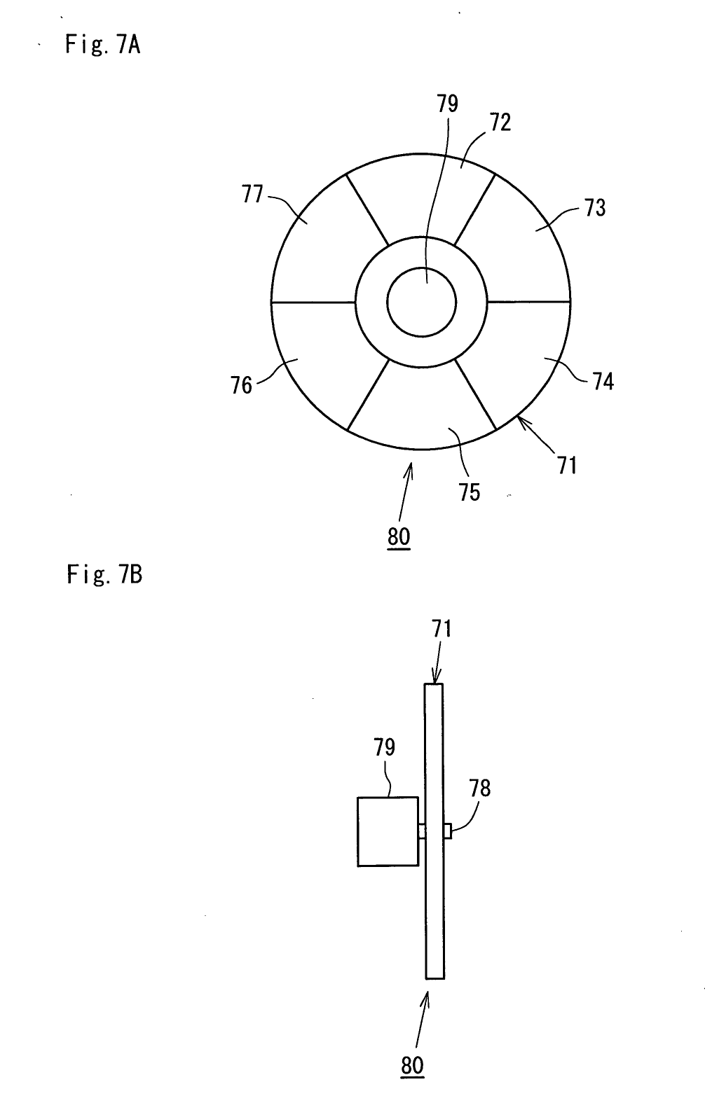

A color wheel assembly according to the present invention will now be described with reference to FIGS. 7A and 7B. A color wheel assembly 80 shown in FIGS. 7A and 7B comprises a color wheel 71 according to the present invention, and a motor 79 to rotate the color wheel 71. A center shaft 78 which is a part of the color wheel 71 is fixedly coupled to a rotary section of the motor 79. The motor 79 is not limited to a specific type and may be, for example, a rotary shaft type spindle motor, wherein the center shaft 78 is fixed to an outer rotor having a magnet and is rotatably supported by bearings disposed inside a stator coil. In the color wheel assembly 80 in the embodiment, filters 72 to 77 of the color wheel 71 formed by the first manufacturing method according to the present invention constitute a pattern whose center point coincides with the center shaft 78, and the center shaft 78 functions as a rotary shaft of the motor 79. The concentricity of the center point of the pattern with the center shaft 78 depends solely on the accuracy in processing the metal mask for forming the filters. The filters of the color wheel shown in FIG. 7A are pie-shaped (sectorial) but may alternatively be spiral-shaped.

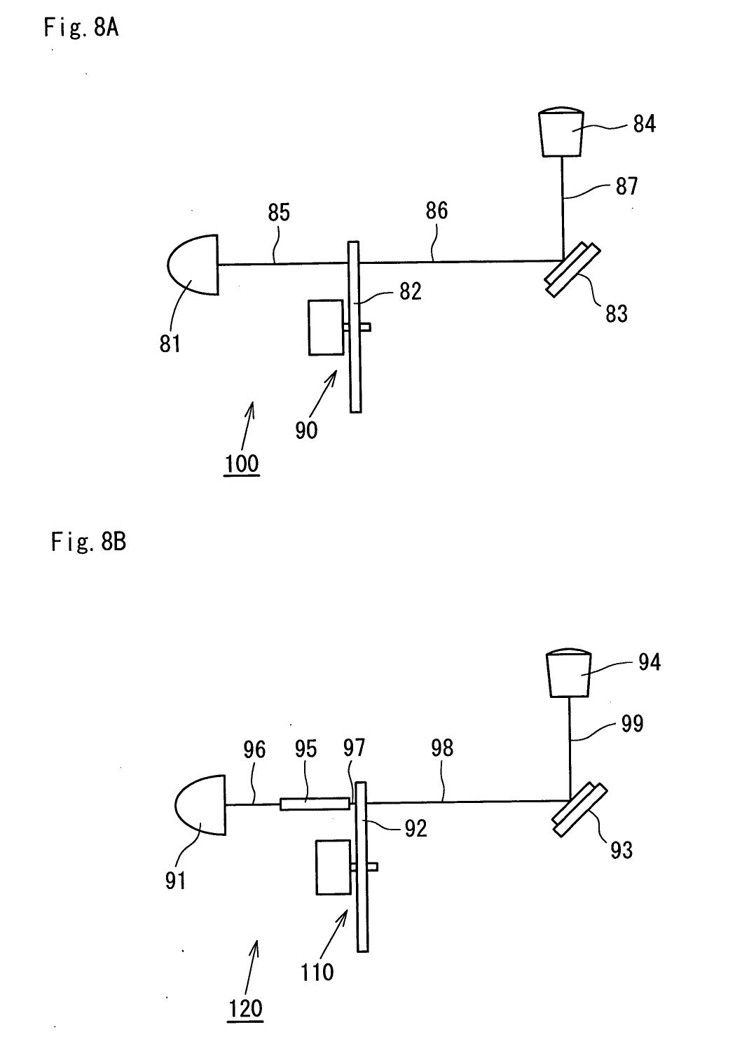

Image display apparatuses according to the present invention will be described with reference to FIGS. 8A and 8B.

Referring first to FIG. 8A, an image display apparatus 100 comprises a white light source 81 constituted by, for example, a metal halide lamp, a color wheel assembly 90 including a color wheel 82, a reflection type light valve element 83 constituted by, for example, a digital micro-mirror device, and a projection lens 84. A white light 85 emitted from the white light source 81 is dispersed by the rotating color wheel 82 sequentially into, for example, R, G and B lights 86 which impinge on the light valve element 83 and are modulated thereby into R, G and B images 87, respectively. The R, G and B images 87 produced are sequentially projected by the projection lens 84 thereby producing a full-color image. The color wheel assembly 90 pertains to a color wheel assembly including a color wheel with pie-shaped filters, for example, the above-described color wheel 20, formed according to the present invention.

Referring now to FIG. 8B, an image display apparatus 120 comprises a white light source 91 constituted by, for example, a metal halide lamp, a color wheel assembly 110 including an SCR system color wheel 92, a reflection type light valve element 93 constituted by, for example, a digital micro-mirror device, a projection lens 94, and an integrator rod 95. The integrator rod 95 is an optical waveguide to equalize a white light 96 emitted from the white light source 91 and guide it to the color wheel assembly 110 and at the same time to reflect returning light reflected at the color wheel 92 back to the color wheel 92 for recycling light. The white light 96 emitted from the white light source 91 passes through the integrator rod 95, gets to the color wheel assembly 110, and is dispersed by densely arranged spiral-shaped filters into R, G and B lights as an exit light 98, which represent strip-shaped zones adjacent to one another, and which coexist in the exit light 98 with their boundaries moving as the color wheel 92 rotates. The light valve element 93 is compartmented into a plurality of sections corresponding respectively to the strip-shaped zones, and the sections operate in synchronization with the movement of the boundaries each defined by the adjacent strip-shaped zones thereby producing an image consisting of R, G and B portions. Then, images consisting of R, G and B portions which carry respective image informations and move are sequentially projected by the projection lens 94, whereby scanning of a picture consisting of scanning lines of three colors is reproduced and a full-color image is produced. The color wheel assembly 110 pertains to a color wheel assembly including a color wheel with spiral-shaped filters, for example, the above-described color wheel 40, formed according to the present invention.

In the image display apparatuses 100 and 120 described above, the light valve elements 83 and 93 are reflection type but may alternatively be transmission type such as liquid crystal light valve elements. And, one skilled in the art will also appreciate that appropriate optical systems and control systems can be additionally included in the image display apparatuses 100 and 120.

Accordingly, it is to be understood that the detailed description of the present invention should be taken as illustrative and not limiting, wherein the scope of the present invention should be determined by the claims that follow.

1. A method for manufacturing a color wheel which is structured such that plural kinds of filters functioning either to selectively transmit or to selectively reflect lights having respective different wavelength bands are formed on a disk-like substrate made of a light-transmittable material, the method comprising the steps of:
forming a substrate assembly composed of the substrate and a center shaft disposed perpendicularly at the substrate;
setting on the substrate assembly a masking jig provided with at least one opening to demarcate respective filters of the plural kinds, wherein the masking jig is positioned with reference to the center shaft; and
forming the respective filters at the substrate assembly with the masking jig set on.

2. A method for manufacturing a color wheel according to claim 1, wherein the step of forming the respective filters includes a process of rotating at least one of the masking jig and the substrate assembly relative to each other about the center shaft of the substrate assembly to thereby shift the at least one opening with respect to the substrate assembly.

3. A method for manufacturing a color wheel according to claim 1, wherein the step of forming the substrate assembly includes a process of molding the substrate and the center shaft into an integral structure.

4. A method for manufacturing a color wheel according to claim 1, wherein the center shaft is made of one of a metal material and a ceramic material.

5. A method for manufacturing a color wheel according to claim 1, wherein the at least one opening is spiral-shaped.

6. A color wheel comprising:
a disk-like substrate made of a light-transmittable material;
a center shaft disposed perpendicularly at the substrate; and
plural kinds of filters formed on the substrate and functioning either to selectively transmit or to selectively reflect lights having respective different wavelength bands, the plural kinds of filters being formed such that a center point of a pattern formed by the filters coincides with the center shaft.

7. A color wheel assembly comprising:
a color wheel including
a disk-like substrate made of a light-transmittable material,
a center shaft disposed perpendicularly at the substrate, and
plural kinds of filters formed on the substrate and functioning either to selectively transmit or to selectively reflect lights having respective different wavelength bands, the plural kinds of filters being formed such that a center point of a pattern formed by the filters coincides with the center shaft; and
a motor to rotate the color wheel, the motor being coupled to the color wheel such that the center shaft also serves as a rotary shaft of the motor.

8. An image display apparatus comprising
a color wheel assembly comprising:
a color wheel including;
a disk-like substrate made of a light-transmittable material,
a center shaft disposed perpendicularly at the substrate, and
plural kinds of filters formed on the substrate and functioning either to selectively transmit or to selectively reflect lights having respective different wavelength bands, the plural kinds of filters being formed such that a center point of a pattern formed by the filters coincides with the center shaft; and
a motor to rotate the color wheel, the motor being coupled to the color wheel such t hat the center shaft also serves as a rotary shaft of the motor.

9. A method for manufacturing a color wheel according to claim 2, wherein the step of forming the substrate assembly includes a process of molding the substrate and the center shaft into an integral structure.

10. A method for manufacturing a color wheel according to claim 2, wherein the center shaft is made of one of a metal material and a ceramic material.

11. A method for manufacturing a color wheel according to claim 3, wherein the center shaft is made of one of a metal material and a ceramic material.

12. A method for manufacturing a color wheel according to claim 2, wherein the at least one opening is spiral-shaped.

13. A method for manufacturing a color wheel according to claim 3, wherein the at least one opening is spiral-shaped.

14. A method for manufacturing a color wheel according to claim 4, wherein the at least one opening is spiral-shaped.
